(19) United States
(12) Patent Application Publication
(10) Pub. No.: US 2007/0176343 A1
(43) Pub. Date: Aug. 2, 2007

(54) ROTARY BRACKET SYSTEM

(75) Inventors: CHAO-GUO HSIEH, Shindian (TW); JIAN-PING JIN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/556,103

(22) Filed: Nov. 2, 2006

(30) Foreign Application Priority Data
Jan. 24, 2006 (CN) 200610033473.7

(51) Int. Cl. B23Q 1/64; B23Q 3/00; B05C 13/00

(52) U.S. Cl. 269/57; 118/500; 269/329

(57) ABSTRACT

An exemplary rotary bracket system includes at least one rotary bracket (10) and at least one anti-vibration system (20). The rotary bracket has a rotary shaft (12). The anti-vibration system includes at least one fixture member (21) and at least one shock-absorber assembly (23) connected to the at least one fixture member. The at least one fixture member fits around the rotary shaft of the at least one rotary bracket such that the rotary shaft is rotatable in the at least one fixture member.

### BACKGROUND OF THE INVENTION

1. Field of the Invention

The present invention generally relates to rotary bracket systems and, more particularly, to a rotary bracket system having an anti-vibration system.

2. Description of Related Art

Spray painting is a well-known manufacturing process, which is commonly used in surface decoration of various articles. In a typical spray painting process, a rotating fixture is used to hold the articles. The rotating fixture has a rotary shaft actuated by a motor, and a holder mounted on the rotary shaft. The articles are fixed on the holder, and can move around the shaft when the motor actuates the rotary shaft to rotate around an axis thereof. A spray gun sprays paint on the moving articles, thus obtaining coatings of uniform thickness on the articles. However, the force of impact of the paint on the articles may cause conical vibration of the rotary shaft. The conical vibration of the rotary shaft can result in collision between articles, which may cause the articles to fall off from the holder. This risk is especially prevalent in a situation where the rotary shaft is rotating at a high speed in the range of, say, 160 to 200 revolutions per minute.

What is needed, therefore, is a rotary bracket system equipped to reduce vibration.

### SUMMARY OF THE INVENTION

In one embodiment, a rotary bracket system is provided. The rotary bracket system includes at least one rotary bracket and at least one anti-vibration system. The rotary bracket has a rotary shaft. The anti-vibration system includes at least one fixture member and at least one shock-absorber assembly connected to the at least one fixture member. The at least one fixture member fits around the rotary shaft of the at least one rotary bracket such that the rotary shaft is rotatable in the at least one fixture member.

Other advantages and novel features will become more apparent from the following detailed description of a preferred embodiment when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present rotary bracket system. Moreover, in the drawings, like reference numerals designate corresponding parts throughout the several views.

FIG. 1 is an isometric view of part of a rotary bracket system according to a preferred embodiment of the present invention.

FIG. 2 is an exploded view of the rotary bracket system shown in FIG. 1.

FIG. 3 is an enlarged view of one of shock-absorber assemblies of the rotary bracket system shown in FIG. 1.

FIG. 4 is an exploded, cutaway view of the shock-absorber assembly shown in FIG. 3.

### DETAILED DESCRIPTION OF THE INVENTION

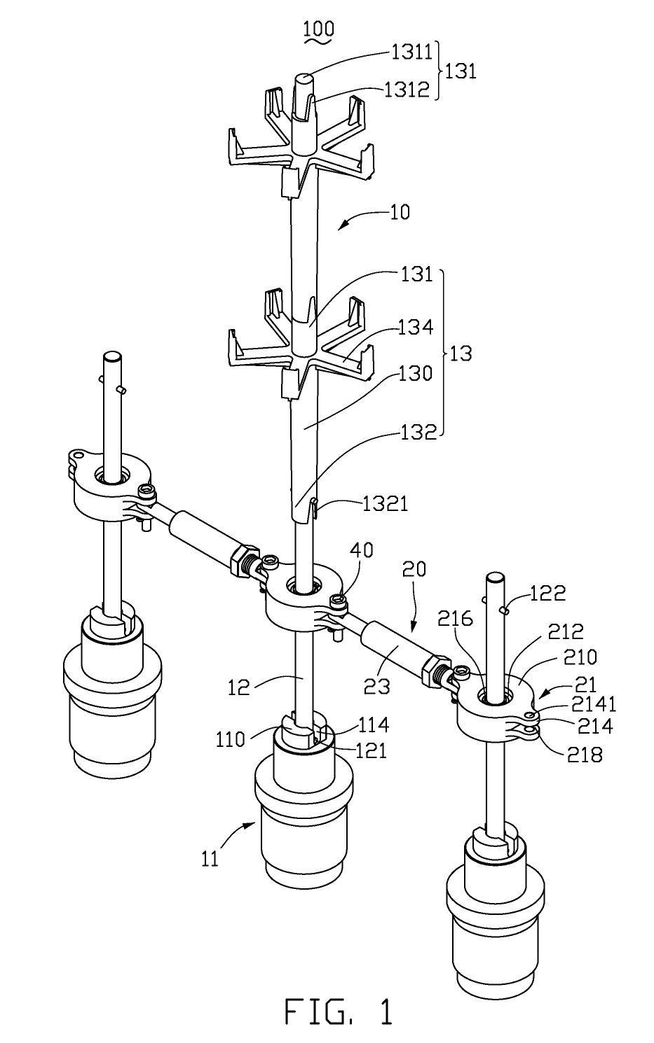

Referring to FIG. 1, a rotary bracket system 100 in accordance with a preferred embodiment includes a plurality of rotary brackets 10 and a plurality of anti-vibration systems 20. In the preferred embodiment, there are three rotary brackets 10 (only the central one shown in full), and two anti-vibration systems 20 interconnecting the three rotary brackets 10.

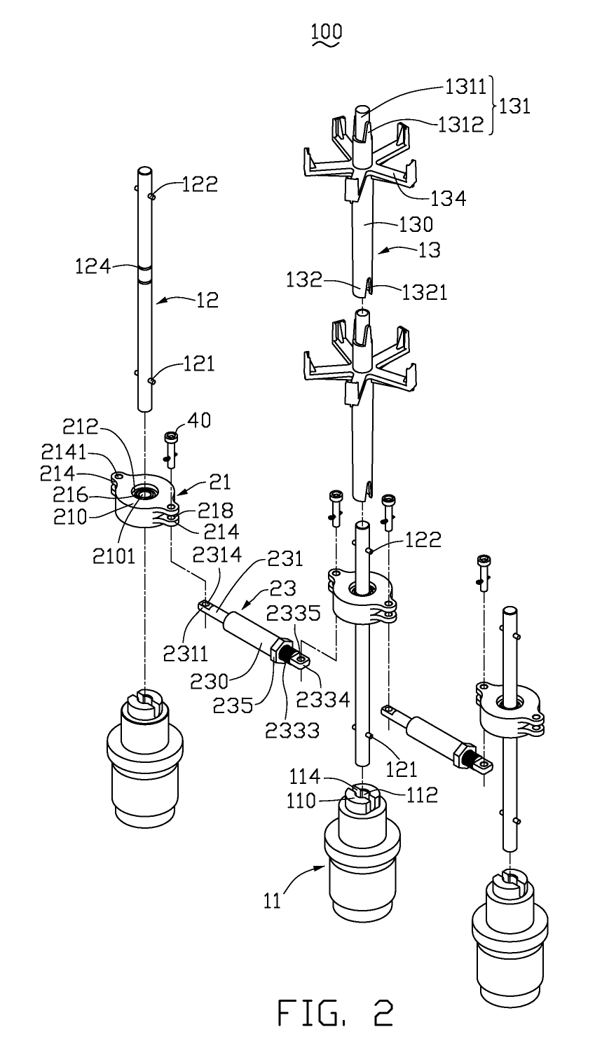

Referring also to FIG. 2, each rotary bracket 10 includes a transmission wheel 11, a rotary shaft 12, and one or more holding brackets 13. In the illustrated embodiment, the central rotary bracket 10 has two holding brackets 13. The transmission wheel 11 is provided with a retaining end 110 for fixing a bottom of the rotary shaft 12 therein. The retaining end 110 has a central hole 112 formed thereon, and a pair of aligned gaps 114 running along a diameter of the retaining end 110.

The rotary shaft 12 can be made of steel. The rotary shaft 12 has a first latching pin 121 and an opposite second latching pin 122. Two annular grooves 124 formed around the middle of the rotary shaft 12. The first latching pin 121 protrudes from opposite sides of a peripheral surface of a first end of the rotary shaft 12, and the second latching pin 122 protrudes from opposite sides of a peripheral surface of an opposite second end of the rotary shaft 12. The first end of the rotary shaft 12 is inserted into the central hole 112 of the retaining end 110, with the first latching pin 121 retained in the gaps 114. Thus the rotary shaft 12 is held in the transmission wheel 11, and can rotate with the transmission wheel 11.

Each holding bracket 13 includes a central shaft 130, and a plurality of retaining arms 134 extending from the central shaft 130 radially for holding workpieces. The central shaft 130 has a column connection end 131, and an opposite sleeve-like connection end 132. The column connection end 131 has a columnar portion 1311, and two U-shaped flange portions 1312 formed symmetrically around the columnar portion 1311. Two U-shaped openings 1321, corresponding to the flange portions 1312, are symmetrically defined in the wall of sleeve-like connection end 132. The columnar portion 1311 of any one of the holding brackets 13 can be engaged in the sleeve-like connection end 132 of another adjoining one of the holding brackets 13. That is, the U-shaped flange portions 1312 of any one of the holding brackets 13 can be engaged in the corresponding U-shaped openings 1321 of the other adjoining one of the holding brackets 13. Thus a series of the holding brackets 13 can be assembled together via engagement of the corresponding column connection ends 131 and sleeve-like connection ends 132. Further, the sleeve-like connection end 132 of a bottom one of the holding brackets 13 can engagingly receive the second end of the rotary shaft 12, with the second latching pin 122 latched in the U-shaped openings 1321. Thus in the illustrated embodiment, both the holding brackets 13 are attached to the rotary shaft 12, and can rotate with the rotary shaft 12.

Each anti-vibration system 20 includes a pair of fixture members 21 and a shock-absorber assembly 23 interconnecting the pair of fixture members 21. In the illustrated embodiment, the two anti-vibration systems 20 share a common central one of three fixture members 21.

Each fixture member 21 includes a main body 210, a bearing member 212 inside the main body 210, and two pairs of flat connecting ears 214 at opposite sides of the main body 210 respectively. The main body 210 has a through hole 2101 defined therein. The bearing member 212 is hollow, and has two snap rings 216 inserted in an inner wall thereof. The bearing member 212 with the snap rings 216 is mounted in the through hole 2101 such that the bearing member 212 can rotate relative to the main body 210. The flat connecting ears 214 are integrally formed with the main body 210. Each flat connecting ear 214 has a positioning hole 2141 defined therein. Each pair of flat connecting ears 214 defines a receiving space 218 therebetween, for receiving one end of a corresponding one of the shock-absorber assemblies 23. The bearing member 212 is fixed around the rotary shaft 12, with the snap rings 216 being locked into the respective annular grooves 124.

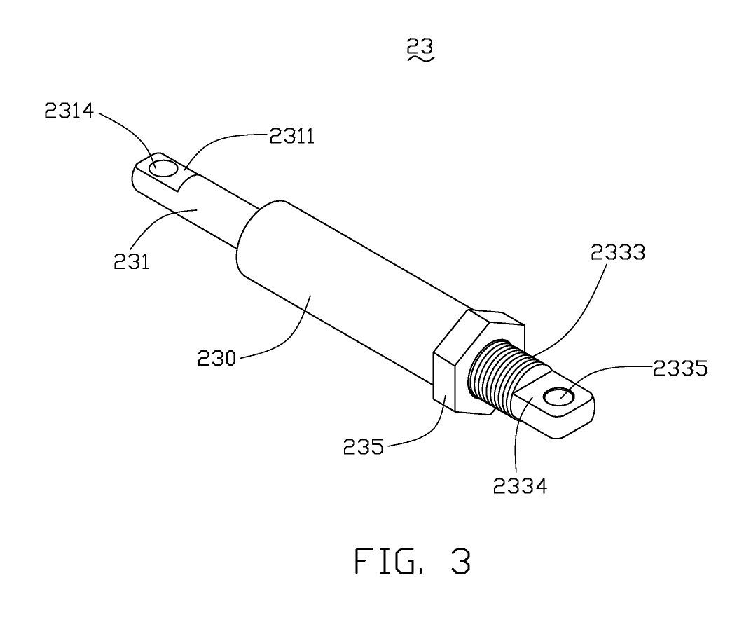

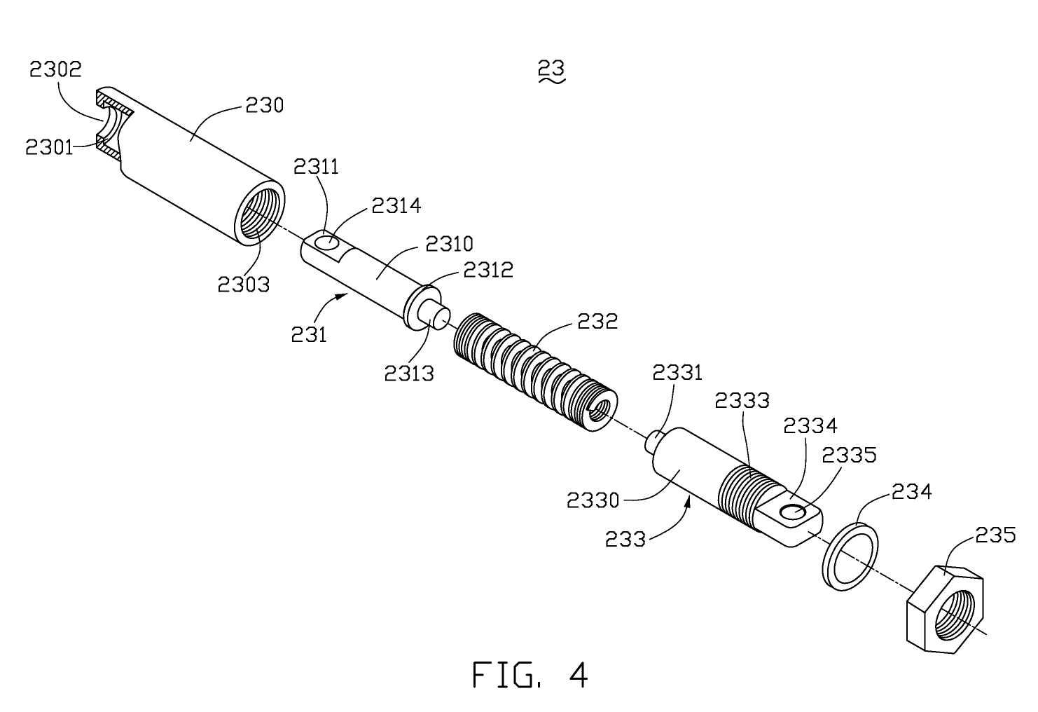

Referring to FIG. 3 and FIG. 4, each shock-absorber assembly 23 includes a sleeve 230, a first connection member 231, a resilient member 232, a second connection member 233, a washer 234, and a screw nut 235. The resilient member 232 can be a coil spring.

The sleeve 230 has a partially enclosed end wall 2301, and an opposite open end. The partially enclosed end wall 2301 has a through opening 2302. The sleeve 230 has an internal thread 2303 adjacent to the open end.

The first connection member 231 has a first cylinder portion 2310, a first flattened shaft portion 2311 formed on one end of the first cylinder portion 2310, a stopper portion 2312 formed on an opposite end of the first cylinder portion 2310, and a first protruding post 2313. The first flattened shaft portion 2311 has a first pinhole 2314 defined therein, and is configured for connecting to a corresponding pair of flat connecting ears 214. The stopper portion 2312 is disc-shaped, and has a diameter larger than that of the first cylinder portion 2310. The first protruding post 2313 extends from the stopper portion 2312, and is coaxial with the first cylinder portion 2310.

The second connection member 233 has a second cylinder portion 2330, a second protruding post 2331, and a second flattened shaft portion 2334. The second cylinder portion 2330 has a cylinder surface comprising an essentially smooth surface and an adjacent external thread 2333. The second protruding post 2331 extends from one end of the second cylinder portion 2330 adjacent to the essentially smooth surface. The second deformed shaft 2334 extends from an opposite end of the second cylinder portion 2330 adjacent to the external thread 2333. The second deformed shaft 2334 has a second pinhole 2335 defined therein, and is configured for connecting to a corresponding pair of flat connecting ears 214.

In assembly of the shock-absorber assembly 23, the first connection member 231 is inserted into the sleeve 230, with the first cylinder portion 2310 and the first flattened shaft portion 2311 extending out of the sleeve 230 through the through opening 2302. The stopper portion 2312 and the first protruding post 2313 are retained in the sleeve 230, with the stopper portion 2312 resisting the inside of the partially enclosed end wall 2301. The resilient member 232 is inserted into the sleeve 230, with one end of the resilient member 232 resisting the stopper portion 2312 and the first protruding post 2313 extending into the inside of the resilient member 232. The second connection member 233 is inserted into the sleeve 230. One end of the second connection member 233, which is adjacent to the second protruding post 2331, resists an opposite end of the resilient member 232. One portion of the external thread 2333 engages with the internal thread 2303 of the sleeve 230, and another other portion of the external thread 2333 is exposed outside the sleeve 230. The washer 234 and the screw nut 235 are nested around the exposed portion of the external thread 2333. The washer 234 is located between the sleeve 230 and the screw nut 235. The first connection member 231 can move along an axis of the sleeve 230, with the resilient member 232 being compressed. Thus assembly of the shock-absorber assembly 23 is completed.

In assembly of the rotary bracket system 100, each of the fixture members 21 is engaged around a corresponding rotary shaft 12, with the snap rings 216 being locked into the annular grooves 124. Each of the shock-absorber assemblies 23 is connected between two neighboring fixture members 21. The first flattened shaft portion 2311 of the first connection member 231 is fixed in the receiving space 218 of a corresponding one of the fixture members 21, via a fixing pin 40 being inserted into and engaged in the positioning holes 2141 and the first pinhole 2314. The second deformed shaft 2334 of the second connection member 233 is fixed in the receiving space 218 of another corresponding one of the fixture members 21, via another fixing pin 40 being inserted into and engaged in the positioning holes 2141 and the second pinhole 2335. Therefore, the neighboring rotary brackets 10 are interconnected with the corresponding anti-vibration systems 20.

In operation of the rotary bracket system 100, each rotary shaft 12 rotates with the corresponding transmission wheel 11. If conical vibration of the rotary shaft 12 occurs, the anti-vibration systems 20 connected between the rotary shaft 12 and each neighboring rotary shaft 12 function as a buffer. The shock-absorber assemblies 23 apply elastic force to the corresponding fixture members 21, so as to reduce the vibration of each rotary shaft 12. Thus articles fixed on the retaining arms 134 of the holding brackets 13 engaged with the rotary shaft 12 are protected from damage. Further, a larger number of holding brackets 13 can be engaged with the rotary shaft 12 with little or no risk of vibration occurring.

It should be understood that in an alternative embodiment, the washer 234 and the screw nut 235 can be omitted. Alternatively, the washer 234 and the screw nut 235 can be replaced by other suitable means (e.g. a snap ring) for keeping the second connection member 233 in position. Further, the first flattened shaft portion 2311 or the second flattened shaft portion 2334 of any of the shock-absorber assemblies 23 can be connected to an external fixture or member instead of the corresponding pair of flat connecting ears 214 of an adjacent fixture member 21.

It should be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rotary bracket system, comprising:
at least one rotary bracket including a rotary shaft; and
at least one anti-vibration system, including at least one fixture member and at least one shock-absorber assembly connected to the at least one fixture member; wherein the at least one fixture member fits around the rotary shaft of the at least one rotary bracket such that the rotary shaft is rotatable in the at least one fixture member.

2. The rotary bracket system as claimed in claim 1, wherein the rotary bracket further includes a transmission wheel and a holding bracket, a first end of the rotary shaft is fixed to the transmission wheel, and an opposite second end of the rotary shaft is engaged with the holding bracket.

3. The rotary bracket system as claimed in claim 2, wherein the transmission wheel includes a retaining end, the retaining end has a central hole and at least one transverse gap, the first end of the rotary shaft has a first latching pin, and the first end of the rotary shaft is received into the central hole with the first latching pin retained in the transverse gap.

4. The rotary bracket system as claimed in claim 2, wherein the holding bracket includes a central shaft, and a plurality of retaining arms radially extending from the central shaft, the retaining arms is configured for holding workpieces.

5. The rotary bracket system as claimed in claim 4, wherein the central shaft has a column connection end, and an opposite sleeve-like connection end, the column connection end has a columnar portion and two U-shaped flange portions formed symmetrically around the columnar portion, and the sleeve-like connection end has two U-shaped openings symmetrically defined in a wall thereof.

6. The rotary bracket system as claimed in claim 1, wherein the at least one fixture member includes a main body and a bearing member, the main body has a through hole, and the bearing member is rotatably mounted to the main body in the through hole and fixed around the rotary shaft.

7. The rotary bracket system as claimed in claim 6, wherein the bearing member has two snap rings inserted therein, the rotary shaft has two annular grooves, and the bearing member is fixed around the rotary shaft with the snap rings being locked in the annular grooves.

8. The rotary bracket system as claimed in claim 6, wherein the main body has two pairs of flat connecting ears symmetrically formed on opposite sides of a peripheral surface thereof, and each pair of flat connecting ears defines a receiving space for receiving a corresponding end of the at least one shock-absorber assembly.

9. The rotary bracket system as claimed in claim 1, wherein the at least one shock-absorber assembly includes a resilient member, a first connection member, and a second connection member, the first connection member resists one end of the resilient member, the second connection member resists an opposite end of the resilient member, and at least one of the first connection member and the second connection member is configured to be connected with the at least one fixture member.

10. The rotary bracket system as claimed in claim 9, wherein the at least one shock-absorber assembly further includes a sleeve and a resilient member received in the sleeve, one end of the first connection member is movably received in the sleeve and resists the resilient member, an opposite end of the first connection member is configured to be connected with the at least one fixture member, one end of the second connection member is received in the sleeve and resists the resilient member, and an opposite end of the second connection member is fixed to the sleeve.

11. The rotary bracket system as claimed in claim 10, wherein the sleeve includes a partially enclosed end and an open end, the partially enclosed end has a through opening, and the sleeve further includes an internal thread adjacent to the open end.

12. The rotary bracket system as claimed in claim 11, wherein the first connection member includes a cylinder portion, a flattened shaft portion extending from one end of the cylinder portion, a stopper portion formed on an opposite end of the cylinder portion, and a protruding post extending from the stopper portion, the cylinder portion and flattened shaft portion protrude out of the sleeve at the through opening, the stopper portion and the protruding post are contained in the sleeve, and when the at least one shock-absorber assembly is in a normal state, the stopper portion resists the partially enclosed end.

13. The rotary bracket system as claimed in claim 11, wherein the second connection member includes a cylinder portion, a protruding post, and a deformed shaft, the cylinder portion has a peripheral surface including an unthreaded portion and an external thread portion, the protruding post extends from one end of the cylinder portion adjacent to the unthreaded portion, the deformed shaft extends from an opposite end of the cylinder portion adjacent to the external thread portion, the end of the cylinder portion at the protruding post resists the resilient member, and the external thread portion is engaged with the internal thread of the sleeve.

14. The rotary bracket system as claimed in claim 13, wherein the at least one shock-absorber assembly further includes a screw nut, one portion of the external thread portion of the cylinder portion is engaged with the internal thread of the sleeve, and the screw nut is engaged with another portion of the external thread portion of the cylinder portion.

15. The rotary bracket system as claimed in claim 10, wherein the resilient member is a coil spring.

16. A rotary bracket system, comprising:
at least one rotary bracket including a rotary shaft; and
at least one anti-vibration system connected with the rotary shaft, and configured to apply elastic force to the rotary shaft in the event of vibration of the rotary shaft such that the at least one anti-vibration system buffers the at least one rotary bracket.

17. The rotary bracket system as claimed in claim 16, wherein the rotary bracket further includes a transmission wheel and a holding bracket, a first end of the rotary shaft is fixed to the transmission wheel, and an opposite second end of the rotary shaft is engaged with the holding bracket.

18. The rotary bracket system as claimed in claim 16, wherein the anti-vibration system includes at least one fixture member and at least one shock-absorber assembly connected to the fixture member, the fixture member fits around the rotary shaft such that the rotary shaft is rotatable in the at least one fixture member.

19. The rotary bracket system as claimed in claim 18, wherein the at least one fixture member includes a main body and a bearing member, the main body has a through hole, and the bearing member is rotatably mounted to the main body in the through hole and fixed around the rotary shaft.

20. The rotary bracket system as claimed in claim 18, wherein the at least one shock-absorber assembly includes a resilient member, a first connection member, and a second connection member, the first connection member resists one end of the resilient member, the second connection member resists an opposite end of the resilient member, and at least one of the first connection member and the second connection member is configured to be connected with the at least one fixture member.
